(19) United States
(12) Patent Application Publication
(10) Pub. No.: US 2022/0394338 A1
(43) Pub. Date: Dec. 8, 2022

(54) MODIFICATION OF CONTENT BASED ON USER INTERACTION SEQUENCES

(71) Applicant: AT&T Intellectual Property I, L.P., Atlanta, GA (US)

(72) Inventors: Eric Zavesky, Austin, TX (US); Vivek Rajasekharan, Plano, TX (US); James Pratt, Round Rock, TX (US)

(21) Appl. No.: 17/342,413

(22) Filed: Jun. 8, 2021

(51) Int. Cl. H04N 21/466; H04N 21/475; H04N 21/258; H04N 21/458

(52) U.S. Cl. CPC H04N 21/4667; H04N 21/4668; H04N 21/4755; H04N 21/25891; H04N 21/4586

(57) ABSTRACT

A processing system may identify a context of a user selection within a content, identify a sequence of known user interactions with the content based on the context, modify the content to include at least one custom selection based on the sequence of known user interactions that is identified, and present the content that is modified to a user.

The present disclosure relates generally to network controlled content modification, and more particularly to methods, non-transitory computer-readable media, and apparatuses for modifying content based on user interaction sequences over a communication network.

### BACKGROUND

Companies may have various applications and/or content that can be presented to a user. A user may navigate through the applications and/or content to arrive at a conclusion of the application and/or content. The content may include menus and drop down choices that allow a user to navigate the content. Typically, the available selections for the menus and/or controls are the same for all users. Thus, each user will try to navigate to their destination or desired conclusion using the same series of menus and/or controls as all the other users.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example of a graphical user interface that presents modified content that includes decision points and wormholes during a sequence of user interactions;

FIG. 3 illustrates a flowchart of an example method for modifying content based on user interaction sequences; and

FIG. 4 illustrates a high level block diagram of a computing device or system specifically programmed to perform the steps, functions, blocks and/or operations described herein.

To facilitate understanding, identical reference numerals have been used, where possible, to designate identical elements that are common to the figures.

### DETAILED DESCRIPTION

The present disclosure broadly discloses an apparatus, method, and non-transitory computer readable medium for modifying content based on user interaction sequences. In one example, a method, executed by a processing system, comprises identifying a context of a user selection within a content, identifying a sequence of known user interactions with the content based on the context, modifying the content to include at least one custom selection based on the sequence of known user interactions that is identified, and presenting the content that is modified to a user.

In another example, a non-transitory computer-readable medium may store instructions which, when executed by a processing system in a communications network, cause the processing system to perform operations. The operations may include identifying a context of a user selection within a content, identifying a sequence of known user interactions with the content based on the context, modifying the content to include at least one custom selection based on the sequence of known user interactions that is identified, and presenting the content that is modified to a user.

In another example, an apparatus may include a processing system including at least one processor and a computer-readable medium storing instructions, which when executed by the processing system, cause the processing system to perform operations. The operations include identifying a context of a user selection within a content, identifying a sequence of known user interactions with the content based on the context, modifying the content to include at least one custom selection based on the sequence of known user interactions that is identified, and presenting the content that is modified to a user.

As noted above, companies may have various applications and/or content that can be presented to a user. A user may navigate through the applications and/or content to arrive at a conclusion of the application and/or content. The content may include menus and drop down choices that allow a user to navigate the content. Typically, the available selections for the menus and/or controls are the same for all users. Thus, each user will try to navigate to their destination using the same series of menus and/or controls as all the other users.

However, users may become frustrated as each user may have different goals or desired outcomes when interacting with the content along a journey, and each user may have different skill level and understanding in how to interact with the content. Typically, the users may have to navigate through selections or have the same content regardless of the user. Many available selections may be irrelevant to the user. This may lead to frustration, a poor user experience, and a feeling of wasted time to navigate through too may selections when interacting with the content.

The present disclosure may modify content based on user interaction sequences. As a result, each user may be presented with modified content that includes custom selections and/or controls for the content. A context of a user's interaction with the content may be identified based on an initial selection and/or A/B testing of one or more prior interactions with the user. Based on the user's initial selections, the communication network may try to identify a sequence of known user interaction associated with the context that is identified.

If a known user interaction sequence is identified, the content may be modified to include custom selections that are different than the default selections. For example, a default company webpage may include menus for information about a company, products, investor relations, user log in, frequently asked questions, and the like. However, the user may select a frequently asked questions selection. Based on the selection, the processing system may determine that the user is likely looking for troubleshooting information for a product.

Using the example of a webpage as the content, the subsequent webpage may include selections for troubleshooting different products. In an example, the webpage may associate an Internet Protocol address of an endpoint device with a customer. The company may know what products the customer owns, e.g., where the customer has various subscribed services and/or where the customer has recently activated a new service. As a result, the subsequent webpage may include selections for troubleshooting products and/or services that the customer owns or has subscribed.

In another example, a company may release a training or tutorial video on how to learn a new game. A user may fast forward an introduction portion of the video. Based on the initial user interaction with the video, the communication network may identify a known sequence of user interactions with the video where the introduction is skipped. For example, users who skip the introduction may be looking for special rules associated with the game that is discussed later in the video. As a result, the content may be modified in subsequent interactions with the user to remove portions of the video and only include the portion of the video that explains the special rules of the game. Thus, a user may not need to fast forward the video again and receive the information that the user is looking for in the video.

The context of the user may be identified using other methods, such as A/B testing. For example, the user may be asked a series of testing questions (or execute one of two pre-defined interaction paths) to identify the context of the user interaction with the content. Based on the user's answers, the content may be modified with custom selections for the user.

In some embodiments, the modified content may include wormholes and/or waypoints. Wormholes may be points within the content that allow a user to jump to another section within the content. For example, the modified content may not be customized perfectly for the user. The wormhole may allow a user to jump to a desired selection or portion of the modified content.

A waypoint may be a decision point. A user may provide input or a decision at the waypoint. The content may be further modified based on the input or decision received from the user at the waypoint. Some waypoints may include suggestions for the user based on the identified known user interaction sequences. The waypoints may attempt to nudge a user towards a predicted outcome associated with the identified known user interaction sequences.

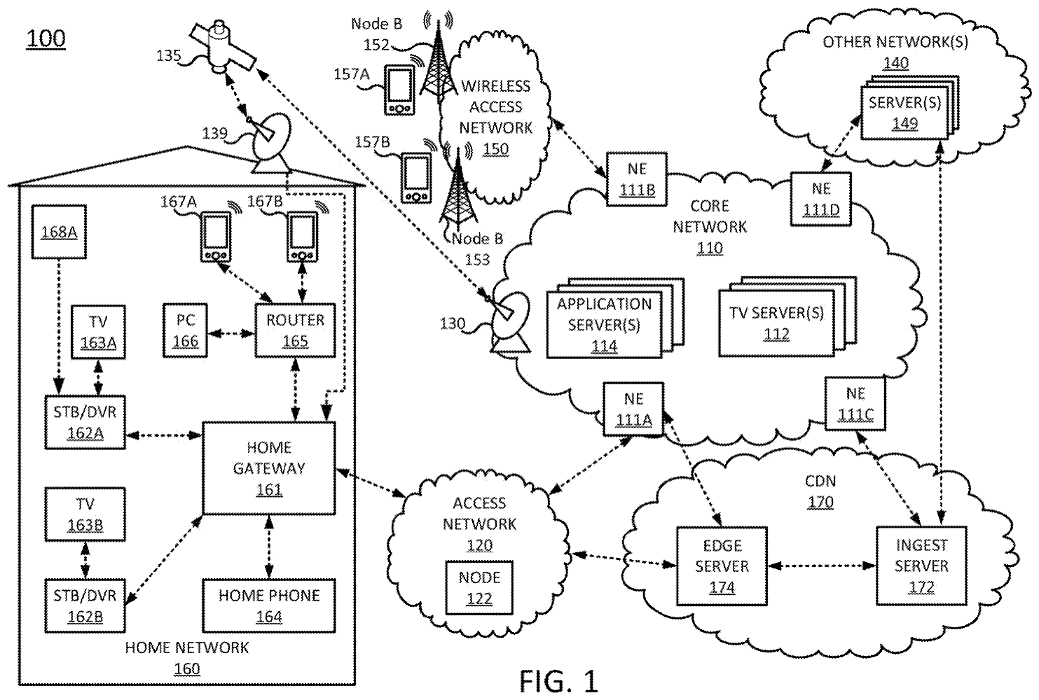

In one example, the modified content may be presented to the user. For example, a graphical user interface may visualize how the content is modified with the custom selections. For example, the skipped or removed selections may be greyed out. The visual presentation of the modified content may allow a user to easily change one or more choices within the content. The change can be propagated through the content to change the custom selections. Thus, some selections that were skipped or removed may no longer be greyed out or may be activated. Thus, a user may make a single change to quickly update or change the modified content without having to go back through each previous selection in the content. These and other aspects of the present disclosure are described in greater detail below in connection with the examples of FIGS. 1-4.

To better understand the present disclosure, FIG. 1 illustrates an example network 100, related to the present examples. As shown in FIG. 1, the network 100 connects mobile devices 157A, 157B, 167A and 167B, and home network devices such as home gateway 161, set-top boxes (STBs) 162A and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140, content distribution network (CDN) 170, and/or the Internet in general. For instance, connections between core network 110, access network 120, home network 160, CDN 170, wireless access network 150 and other networks 140 may comprise the Internet in general, internal links under the control of single telecommunication service provider network, links between peer networks, and so forth.

In one example, wireless access network 150 may comprise a radio access network implementing such technologies as: Global System for Mobile Communication (GSM), e.g., a Base Station Subsystem (BSS), or IS-95, a Universal Mobile Telecommunications System (UMTS) network employing Wideband Code Division Multiple Access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G) or any other yet to be developed future wireless/cellular network technology. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB). In one example, wireless access network 150 may be controlled and/or operated by a same entity as core network 110.

In one example, each of the mobile devices 157A, 157B, 167A, and 167B may comprise any subscriber/customer endpoint device (or “user endpoint device”) configured for wireless communication such as a laptop computer, a Wi-Fi device, a Personal Digital Assistant (PDA), a mobile phone, a smartphone, an email device, a computing tablet, a messaging device, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, wireless access network 150, access network 120, and so forth. As shown in FIG. 1, core network 110 may also include a plurality of television (TV) servers 112, and a plurality of application servers 114. For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may include content server(s) to store scheduled television broadcast content for a number of television channels, video-on-demand (VoD) programming, local programming content, and so forth. Alternatively, or in addition, content providers may stream various contents to the core network 110 for distribution to various subscribers, e.g., for live content, such as news programming, sporting events, and the like. Television servers 112 may also include advertising server(s) to store a number of advertisements that can be selected for presentation to viewers, e.g., in the home network 160 and at other downstream viewing locations. For example, advertisers may upload various advertising content to the core network 110 to be distributed to various viewers. Television servers 112 may also include interactive TV/video-on-demand (VoD) server(s) and/or network-based digital video recorder (DVR) servers, as described in greater detail below.

In one example, the access network 120 may comprise a fiber access network, a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other types of television service to subscribers via access network 120. In this regard, access network 120 may include a node 122, e.g., a mini-fiber node (MFN), a video-ready access device (VRAD) or the like. However, in another example, node 122 may be omitted, e.g., for fiber-to-the-premises (FTTP) installations. Access network 120 may also transmit and receive communications between home network 160 and core network 110 relating to voice telephone calls, communications with web servers via other networks 140, content distribution network (CDN) 170 and/or the Internet in general, and so forth. In another example, access network 120 may be operated by a different entity from core network 110, e.g., an Internet service provider (ISP) network.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

As illustrated in FIG. 1, core network 110 may include various application servers 114. For instance, application servers 114 may be implemented to provide certain functions or features, e.g., a Serving—Call Session Control Function (S-CSCF), a Proxy—Call Session Control Function (P-CSCF), or an Interrogating—Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. In one embodiment, the application servers 114 may include memory or a database to store call records associated with telephone calls and/or interaction with the IVR systems.

The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like. It should be noted that the foregoing are only several examples of the types of relevant application servers 114 that may be included in core network 110 for storing information relevant to providing various services to users.

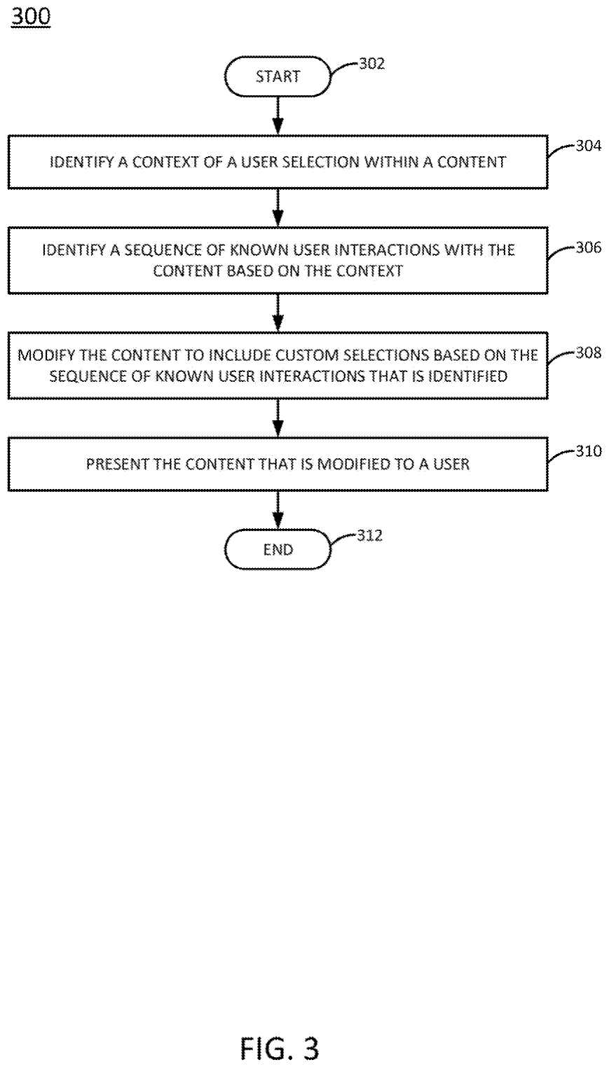

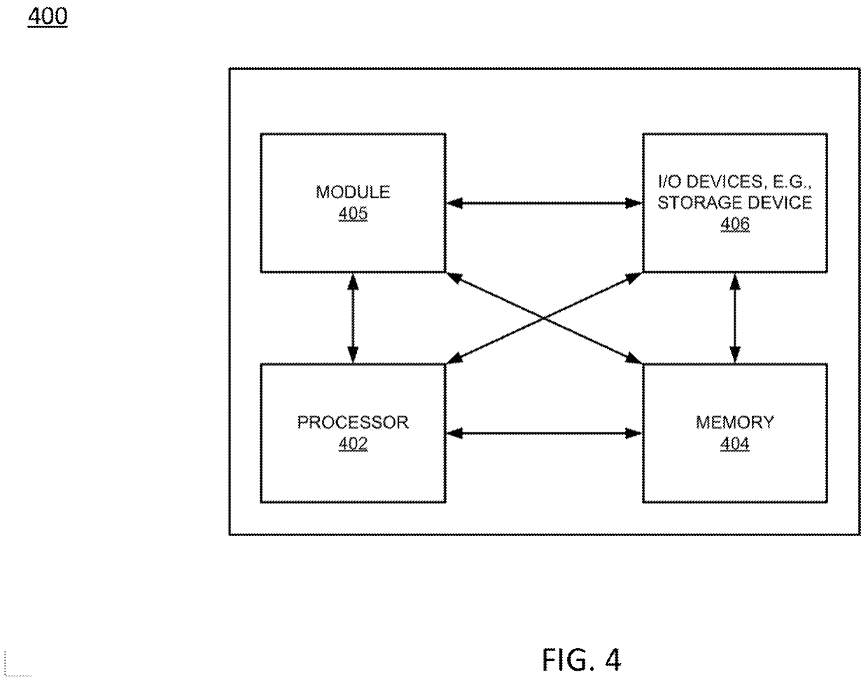

Application servers 114 may also represent a processing system for modifying content based on user interaction sequences. For instance, one or more of application servers 114 may each comprise a computing device or processing system, such as computing system 400 depicted in FIG. 4, and may be configured to perform one or more steps, functions, or operations for modifying content based on user interaction sequences. For instance, an example method for modifying content based on user interaction sequences is illustrated in FIG. 3 and described below.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In accordance with the present disclosure, other networks 140 and servers 149 may comprise networks and devices of various content providers of webpages, documents, videos, or other content items. In one example, servers 149 may represent “origin servers” which may originate content that may be stored in and distributed via content distribution network (CDN) 170. In this regard, the content from servers 149 that may be stored in and distributed via content distribution network (CDN) 170 may include webpages, documents, audio programs, video programs, e.g., movies, television shows, video news programs, sports video content, and so forth, as well as video advertisements.

In one embodiment, the other networks 140 and servers 149 may also include local networks of retail establishments and local servers that collect in-store interaction data. For example, the other network may be a WiFi network of a retail establishment. The server 149 may collect user interaction data of an endpoint device of a user that is connected to the WiFi network at the retail establishment. The server 149 may also collect in-store user interaction data recorded by an employee that records the details of a user interaction (e.g., customer information, details of a product or service a customer was looking for, and the like).

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions comprise a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections. Although STB/DVR 162A and STB/DVR 162B are illustrated and described as integrated devices with both STB and DVR functions, in other, further, and different examples, STB/DVR 162A and/or STB/DVR 162B may comprise separate STB and DVR devices.

Network 100 may also include a content distribution network (CDN) 170. In one example, CDN 170 may be operated by a different entity from the core network 110. In another example, CDN 170 may be operated by a same entity as the core network 110, e.g., a telecommunication service provider. In one example, the CDN 170 may comprise a collection of cache servers distributed across a large geographical area and organized in a tier structure. The first tier may comprise a group of servers that accesses content web servers (e.g., origin servers) to pull content into the CDN 170, referred to as an ingestion servers, e.g., ingest server 172. The content may include videos, content of various webpages, electronic documents, video games, etc. A last tier may comprise cache servers which deliver content to end users, referred to as edge caches, or edge servers, e.g., edge server 174. For ease of illustration, a single ingest server 172 and a single edge server 174 are shown in FIG. 1. In between the ingest server 172 and edge server 174, there may be several layers of servers (omitted from the illustrations), referred to as the middle tier. In one example, the edge server 174 may be multi-tenant, serving multiple content providers, such as core network 110, content providers associated with server(s) 149 in other network(s) 140, and so forth.

As mentioned above, TV servers 112 in core network 110 may also include one or more interactive TV/video-on-demand (VoD) servers and/or network-based DVR servers. Among other things, an interactive TV/VoD server and/or network-based DVR server may function as a server for STB/DVR 162A and/or STB/DVR 162B, one or more of mobile devices 157A, 157B, 167A and 167B, and/or PC 166 operating as a client video player. For example, STB/DVR 162A may present a user interface and receive one or more inputs (e.g., via remote control 168A) for a selection of a video. STB/DVR 162A may request the video from an interactive TV/VoD server and/or network-based DVR server, which may retrieve a manifest file for the video from one or more of application servers 114 and provide the manifest file to STB/DVR 162A. STB/DVR 162A may then obtain one or more portions of the video from one or more network-based servers, such as one of the TV servers 112, edge server 174 in CDN 170, and so forth, as directed via the manifest file. For instance, URL(s) and other information that may be used by a player device to request and obtain chunks of adaptive or non-adaptive bitrate video may be stored in the manifest file which may be obtained by the player device in advance of a streaming session.

To illustrate, the manifest file may direct the STB/DVR 162A to obtain the video from edge server 174 in CDN 170. The edge server 174 may already store the video (or at least a portion thereof) and may deliver the video upon a request from the STB/DVR 162A. However, if the edge server 174 does not already store the video, upon request from the STB/DVR 162A, the edge server 174 may in turn request the video from an origin server. The origin server which stores the video may comprise, for example, one of the servers 149 or one of the TV servers 112. The video may be obtained from an origin server via ingest server 172 before passing the video to the edge server 174. In one example, the ingest server 172 may also pass the video to other middle tier servers and/or other edge servers (not shown) of CDN 170. The edge server 174 may then deliver the video to the STB/DVR 162A and may store the video until the video is removed or overwritten from the edge server 174 according to any number of criteria, such as a least recently used (LRU) algorithm for determining which content to keep in the edge server 174 and which content to delete and/or overwrite.

It should be noted that a similar process may involve other devices, such as TV 163A or TV 163B (e.g., “smart” TVs), mobile devices 167A, 167B, 157A or 157B obtaining a manifest file for a video from one of the TV servers 112, from one of the servers 149, etc., and requesting and obtaining videos (e.g., the video chunks thereof) from edge server 174 of CDN 170 in accordance with corresponding URLs in the manifest file.

As mentioned above, one or more of the application servers 114 may represent a processing system for modifying content based on user interaction sequences. The content may include automated user interaction interfaces such as a web page or an interactive voice response (IVR) system. The content may also include one or more videos. The content may be presented by the application server(s) 114 to an endpoint device of a user (e.g., mobile devices 157A, 157B, 167A, and 167B, PC 166, TVs 163A and 163B, and the like).

In one embodiment, the application servers 114 may modify the content based on the user interaction sequences. For example, the application servers 114 may determine a context of a user selection within the content. Based on the context, a sequence of known user interactions associated with the context may be identified and used to modify the content. The content may be modified to include custom selections that are made in the sequence of known user interactions associated with the context that is identified. In other words, irrelevant or unused selections may be removed to allow a user to save time from having to navigate through the content to reach a desired destination or outcome. As a result, selections that are available in the content, or the portions of the content may be tailored, or customized, for each user based on a predicted result or outcome the user desires.

For example, the content may be a webpage that includes a series of drop down menus. A default webpage may include certain available selections. After an initial selection of one of the available selections in the webpage, the context of the user (e.g., the predicted user desired outcome) may be determined to identify a sequence of known user interactions. To illustrate, a user may select a frequently asked questions tab on the webpage. The context may be determined that the user is looking to have a question about troubleshooting a product or a service answered. The sequence of known user interactions within this context may include users that typically click on a link for a particular product, or click on links for customer support, and then a link for contact us. Thus, the webpage may be modified for the user to include links to different models of products offered by the company and customer support information (e.g., phone numbers, link to chat, email address, and the like) on the page.

In other words, a default webpage may show a list of all the frequently asked questions when the link to frequently asked questions is selected. However, the present disclosure may predict the context of the initial selection of the user and modify the webpage to include links and/or information the user will likely desire to achieve the outcome when the frequently asked questions link is selected. Thus, the modified content that is presented to the user will accelerate the process for the user in reaching its desired goal.

As noted above, the content may include IVR, videos, and the like. For example, in an IVR system a menu may associate options with numerical keys. For example, the IVR system may indicate to press 1 for a new order, press 2 for help with an existing order, press 3 for account information, or press 4 for technical assistance, or press 5 for additional options. When pressing 3, the IVR system may then present a series of additional options. For example, the IVR system may indicate to press 1 to hear account status, press 2 to hear your current invoice, press 3 to pay your bill, press 4 to hear bills previously paid, and press 5 to hear available payment methods. When 3 is selected, the IVR system may provide further instructions and options to pay a customer's bill, e.g., the amount to be paid (e.g., full amount of the bill, partial amount of the bill, or an amount above the current bill), the method of payment method (e.g., credit card, checking account, or debit account), the date to pay the bill (e.g., paying the bill now or scheduling a particular date in the future for the bill to be paid), generating a confirmation number (e.g., generating and presenting a confirmation number to the user for the transaction) and so on. However, when the user initially presses 3, the application server 114 may determine in this instance, this particular user is likely looking to pay the user's entire bill one day before the due date with a particular credit card number. Thus, instead of presenting a series of options, the IVR system may directly ask the user if the user wants to pay his or her bill using a previous method of payment. In another example, when the user presses 3, the IVR may simply reply “Your current bill in the amount of $40.00 will be paid one day before the due date of January 15 using credit card number XXXXXXXXXXXXXX, thank you for your scheduled payment, you may hang up now or press * to cancel this scheduled payment.” Thus, the user may skip listening to all of the available options for account information under option 3 and the process of interaction with the user can be expedited with the bill being paid with a previous payment method.

In one embodiment, a video may be modified based on the context of a user's initial selection. For example, a user may fast forward an introduction to a video tutorial on a new game. The application server 114 may determine that users who skip the introduction are typically experienced users that are looking for special rules associated with the game. Thus, the application server 114 may modify the video to remove portions that are unrelated to the special rules or modify the video to only include the portions that discuss the special rules. The application server 114 may then stop the fast forward selection and immediately skip to the beginning of the modified content. Thus, the modified content can be presented in a current user interaction and/or in a future user interaction (e.g., a future interaction with the user will have all of the introduction portions removed).

In one embodiment, the context may be identified using machine learning models. For example, previous user interaction sequences with the content may be fed to a machine learning model to train the machine learning model to identify sequences of known user interactions that are likely based on the context of an initial user selection. The machine learning model may then provide probabilities of sequences of known user interactions that best match the likely sequence of user interactions based on the context. The sequence with the highest probability may be identified as the sequence of known user interactions that is likely. The application server may then dynamically modify the content in accordance with the sequence of known user interactions.

In one example, the machine learning model may comprise a recurrent neural network (RNN). However, in other examples, the machine learning model may take a different form. In this regard, it should be noted that as referred to herein, a machine learning model (MLM) (or machine learning-based model) may comprise a machine learning algorithm (MLA) that has been “trained” or configured in accordance with input data (e.g., training data) to perform a particular service, e.g., to detect a user interaction context to create a modified content for presentation to the user to expedite a user interaction with a system. Thus, in other examples, the present disclosure may incorporate various types of MLAs/models that utilize training data, such as a support vector machine (SVM), e.g., a linear or non-linear binary classifier, a multi-class classifier, a deep learning algorithm/model, such as another type of deep learning neural network or deep neural network (DNN), a generative adversarial network (GAN), a decision tree algorithms/models, such as gradient boosted decision tree (GBDT), a k-nearest neighbor (KNN) clustering algorithm/model, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth.

In one embodiment, the context may be determined based on a user's response to A/B testing. For example, two users with similar demographics, profiles, context, or other traits—all of which are included in the machine learning as inputs—may be given alternate forms of content, whether this content is a website, IVR, or video. The system may then monitor the user's progress through the content and look for extra “pain points” (e.g. waypoints where the user took a longer amount of time for response, consulted help, or skipped a response), “funnel exit” (e.g. waypoints where the user left the content entirely), and overall engagement (e.g. counts of clicks, user attentiveness, interaction with the content, etc.). Over a large number of users and these two content variants, the system may learn patterns and make conclusions (which may themselves be alternate A/B tests) about the benefits of particular content choices. Through this embodiment, the application server 114 may determine the context and identify a sequence of known user interactions based on the context.

In one embodiment, the context may also be based on user information or account information associated with a user. For example, in an example, the application server 114 may associate an IP address of a mobile device 167A with a particular user. The application server 114 may recognize that the user associated with the IP address of the mobile device 167A has a particular model of a mobile device. The user may then access a webpage of the service provider. The user may make an initial selection of a menu option on the webpage. The application server 114 may determine a context of the initial selection, as described above, but also consider the user information (e.g., the model of the mobile device 167A). Thus, a user may click on a selection for “technical support” on the webpage. The application server 114 may determine the context of the initial selection based on a machine learning model or A/B testing to be resolving a problem with a device, as described above. The application server 114 may also determine that the IP address of the mobile device 167A accessing the webpage is associated with a user who has a particular model of the mobile device and a particular router for home Internet access. Thus, the application server 114 may redirect the user to a modified web page for the user after the user selects the “technical support” link that includes custom selections for the user based on the identified context. For example, the webpage may include links for the trouble shooting the model of the mobile device and links for trouble shooting the model of the router. In contrast, the default webpage may be a page that includes questions about what type of troubleshooting the user would like to perform and on what product. The default webpage may include links to a variety of different products, where the user would previously have to click on a category of products, then a brand of the product, then find the model of the mobile device owned by the user. Using the default webpage, the user would have to remember his or her model of the mobile device and the model of the router in order to make the appropriate selections from the default webpage. This creates a cumbersome experience for the user and prolongs the user interaction with the system. In other words, the user will be required to expend a greater amount of time to achieve its goal.

In one embodiment, the modified content may include waypoints and/or wormholes. Waypoints may be a decision point. A user may provide input or a decision at the waypoint. The content may be further modified based on the input or decision received from the user at the waypoint. Some waypoints may include suggestions for the user based on the identified known user interaction sequences. The waypoints may attempt to nudge a user towards a predicted outcome associated with the identified known user interaction sequences.

Wormholes may be points within the content that allow a user to quickly jump to another section within the content. For example, the modified content may not be customized perfectly for the user. The wormhole may allow a user to jump to a desired selection or portion of the modified content.

In one embodiment, the context of the user's selections may be continuously updated as users make selections at waypoints or jump to other portions of the content using the wormholes. The application server 114 may automatically propagate changes to selections caused by a selection at a waypoint and update the context and the modified content accordingly.

In one embodiment, the modified content can be presented to a user graphically. The graphical presentation of the modified content may visualize how the content has been modified based on the context of the user and illustrate changes to the content from the default content. The graphical representation may provide possible waypoints where users can change selections and/or wormholes where users can jump to different portions of the modified content, or to different types of modified content, to reach a desired outcome.

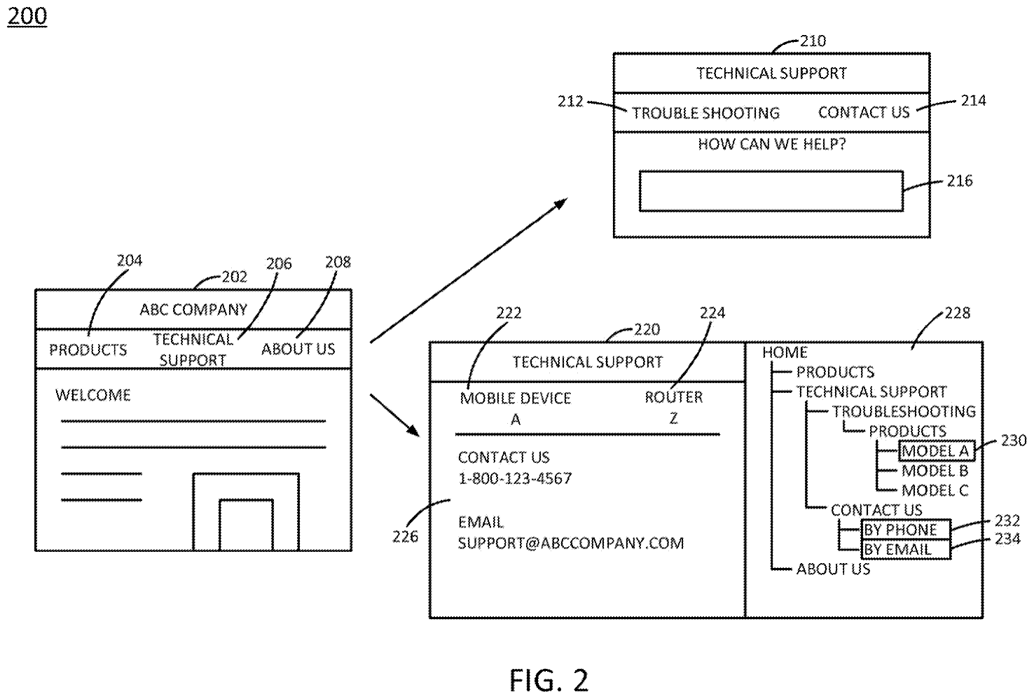

The user may be able to change any previous selections using the graphical representation without having to change each selection one-by-one in a serial order. The application server 114 may propagate the changes through the selections and modify the content accordingly. The graphical representation may then be updated to visually show how the changed selections affected how the content was modified. FIG. 2 illustrates an example of the graphical representation and will be described below.

In some embodiments, a notification may be presented to the user before the modified content is presented. For example, the notification may indicate that a prediction about a user's context has been made and that the content may be modified (e.g., the system may dynamically present to the user the detected context, e.g., “We believe you are only looking for special rules in the game,” “We believe you want to pay your bill in full,” “We believe you want to troubleshot your model ‘xxxx’ device” and so on). A confirmation from the user may be requested to receive the modified content. Some users may want to still click through the series of selections presented in the default content or watch the entire video or manually find the desired portions of video. User feedback may be used to improve the system's predictions, e.g. if a significant percentage of users turn away from the modified content the system may be updated to show different modified content or the default content.

In another embodiment, the user may be skipped to another waypoint in the process and provided only visual breadcrumbs to indicate that a wormhole was utilized. For example, if there are enumerated steps one through five, checkmarks or other completion graphics may be applied to steps one, two, and three if a wormhole was utilized to skip to waypoint four. This embodiment may be utilized to automatically accelerate the user experience but de-emphasize (as a means of avoiding distraction or adding confusions) the actual process of taking the wormhole.

It should be noted that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

FIG. 2 illustrates an example of a graphical user interface that presents modified content that includes decision points and wormholes during a sequence of user interactions. The example illustrated in FIG. 2 illustrates an example of the content as a webpage 202. However, as noted above, the content may be a video or an audio presented via an IVR, and the like.

The webpage 202 for an enterprise may have a homepage. Every user may arrive at the same homepage. The home page may include links 204, 206, and 208. Each link 204, 206, and 208 may include additional nested available selections or links. For example, the link 204 may be for products. When a user selects the link 204, a further list of available options may be shown. For example, the link 204 may show categories of products. Then when a category is selected, further selections may be shown that include different models of the product. When a model is selected, the user may be taken to a webpage that includes details about the product with additional links or available menu selections.

The webpage 210 illustrates a default webpage that may be shown when a user selects the link 206 for technical support. For example, when there is not enough data to determine a context based on the initial selection of the link 206, the user may be taken to the default webpage 210. The default webpage 210 may include links 212 for troubleshooting and a link 214 for contact information. The default webpage 210 may also include an information field 216 to collect information from the user (e.g., how the enterprise can help resolve a problem).

Over time, user interactions with the content or webpages 202 and 210 may be collected. A machine learning model may be trained to determine a context of a selection made by a user. For example, when a user selects the link 206, the machine learning model may predict that context of the user selection is to resolve a problem with a particular product.

Also, as noted above, account information associated with the user may be accessed to modify content based on the context that is determined. For example, the IP address of the endpoint device may be identified with a particular user who owns a model A mobile device and a model Z router. Thus, the machine learning model may determine that a sequence of known user interactions associated with the context of the user selection is to access a link for troubleshooting (e.g., the identified context), find the model of the products owned by the user, and sometimes contact technical support. Thus, the webpage 210 may be modified to present modified webpage 220 to the user to include custom selections. In other words, instead of directing a user to the webpage 210 when the link 206 is selected, the present disclosure may redirect the user to webpage 220 that has been modified based on the context of the user's initial selection of link 206.

In one embodiment, the modified webpage 220 with the custom selections may include a link to the model A mobile device and the model Z router that the user owns prominently displayed on the modified webpage 220, thereby alleviating the user from having to search for these product on the webpage. In other words, rather than the default selections of a link 212 and 214 found in the default webpage 210, the modified webpage 220 may include custom selections based on the context of troubleshooting that was identified based on the user selection from the homepage. In addition, the modified webpage 220 may include contact information 226 (e.g., a telephone number to contact technical assistance and/or an email).

In one embodiment, the selections made from the modified webpage 220 may be analyzed for additional context to receive additional content. For example, the telephone number in the modified webpage 220 may be a wormhole to jump a user directly to a live customer service representative. For example, when a user dials the telephone number directly without access the modified webpage 220, the user may be presented with a series of menu options of an IVR system. However, the present disclosure may recognize that the user needs help with a solution to a technical problem that was not found in the modified webpage 220. Thus, when a user calls the telephone number from the modified webpage 220, the menu options may be completely skipped in the IVR system and the user may be directly connected to a live representative. Thus, the modified content may include wormholes that allow users to jump from one modified content to another point in a different type of modified content to achieve a desired outcome quickly.

In one embodiment, the modified webpage 220 may also present a visual representation 228 of the modified content. The visual representation 228 may be presented in a tree structure or any other organized structures. The visual representation 228 may be presented for a modified IVR system in a webpage when a user calls into an IVR system, or may be shown on the screen for a modified video content.

The visual representation 228 may allow a user to see what selections were skipped to arrive at the modified webpage 220. The visual representation 228 may highlight certain selections (e.g., selections 230, 232, and 234 may be highlighted) to allow a user to see what is included in the modified webpage 220. This will allow the user to visually ascertain how the system was attempting to expedite the user's interaction with the system based on the detected context. This visual representation 228 will also allow the user to make any necessary changes if the detected context was inaccurate or the user has other desired goals to achieve.

The visual representation 228 may also allow the user to see what selections may have been missed. The user may navigate through the visual representation 228 to change selections made while interacting with the content (e.g., the webpage 202 and any subsequently visited webpages). Thus, a user may change any selection at a single point. The application server or processing system may then automatically update the context based on the changes, propagate the changes through the series of selections, if necessary, and update the modified content that is presented to the user. The application server may use historical data of collected user responses as positive and negative feedback to improve suggestions over time. The changes may be reflected in the visual representation 228. For example, different selections may be highlighted or greyed out.

In one embodiment, the visual representation 228 may also include wormholes. For example, some selections in the visual representation 228 may allow a user to quickly jump to another type of content. For example, a selection in the visual representation 228 may allow a user to jump from the modified webpage 220 to a modified video content. As noted above, calling a telephone number may allow a user to jump from the modified webpage 220 to a live representative without having to listen to an entire presentation of menu options of the IVR system.

Thus, the present disclosure may allow a user to reach a desired outcome more efficiently and quickly. The present disclosure may identify a context of a user based on an initial selection within a content and provide modified content based on the context that is identified. The user may change selections in a granular fashion (e.g., change a selection at a single point) and the changes may be automatically propagated through the series of selections to update or change how the content is modified for the user. Based on selections made by the user, the present disclosure may also provide suggestions or nudge a user towards a desired outcome. The sequence of interactions of the user may be used to continually update the machine learning model to provide more accuracy in identifying a context of a user's selections and modifying content in accordance with a sequence of known user interactions.

FIG. 3 illustrates a flowchart of a method 300 for modifying content based on user interaction sequences, in accordance with the present disclosure. In one example, the method 300 is performed by one or more of the application server(s) 114 of FIG. 1, or any one or more components thereof, such as a processing system, or by one of these devices in conjunction with other devices and/or components of network 100 of FIG. 1. In one example, the steps, functions, or operations of method 300 may be performed by a computing device or system 400, and/or a processing system 402 as described in connection with FIG. 4 below. For instance, the computing device or system 400 may represent any one or more components of the network 100 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system, and each instance may represent one of the application servers 114, edge server 174, ingest server 172, TV servers 112, and so forth in FIG. 1. For illustrative purposes, the method 300 is described in greater detail below in connection with an example performed by a processing system, such as processing system 402. The method 300 begins in step 302 and proceeds to step 304.

At step 304, the processing system identifies a context of a user selection within a content. The context may be determined based on an initial selection of a user within the content, a series of selections made by a user, answers to a series of testing questions (A/B testing) presented to a user, past user interaction of this user with a system, and the like.

In one embodiment, the context may be determined based on an output of a machine learning model. For example, sequences of user interaction data may be provided to a machine learning model to train the model. The trained machine learning model may then learn the possible contexts of a selection made by a user. For example, based on the selection within the content made by a user the machine learning model may determine that the context is troubleshooting, wanting to pay a bill, looking for certain information within a video, looking for a particular product, signing up for a service, cancelling a service, looking for certain types of scenes within a video, looking for a live representative when interacting with an IVR system, and the like.

At step 306, the processing system identifies a sequence of known user interactions with content based on the context. Once the context is determined, a sequence of known user interactions may be identified. For example, if the context is troubleshooting, the sequence of known user interactions may be to find a model of a particular product through a series of menu selections on a webpage and find a frequently asked questions webpage for a particular problem associated with the model of the particular product.

In one embodiment, a sequence may be encoded using the user's entire journey (e.g. from initial interaction with the system in a context to their current interaction) or just a fragment of that journey (e.g. the sequence of activities between the current waypoint and a previous waypoint). This encoding may be a numerical representation of interaction points capturing only the updates or interactions that the user made (e.g. through scrolling, textual input, etc.) as opposed to all input points that were not modified (e.g. default entries that were automatically detected, filled, and remain unchanged by the user).

In another example, the encoding may also be the complete set of inputs from the user and his or her context—again rendered into numerical representations and place holder values for textual categories. In both of these examples, this sequence can be utilized as a fingerprint with which matches from other user journeys are indexed and compared. In one embodiment, this index may include all prior journeys completed by this user, optionally indexed at segments between each waypoint. In another embodiment, this index may include all prior journeys completed by all prior users—with optional filtering or matching between those users' contexts, demographics, profiles, etc. Continuing the primary example, with an index containing encoded sequences, a machine learning system may computationally match and evaluate the fitness of advancing a user to a different waypoint in the user journey. This advancement (e.g. the use of a wormhole to another waypoint) may be the sequences realized in step 306 as the modifications that may be passed to step 308.

At step 308, the processing system modifies the content to include custom selections based on the sequence of known user interactions that is identified. For example, the content may be modified to skip the sequence of selections that would normally occur if the content was not modified. The content may be modified to allow a user to reach a desired outcome that is predicted based on the identified context more quickly and efficiently. Thus, in the above example, when the user selects a link for troubleshooting, rather than requiring the user to navigate through a sequence of menu selections, the user may be directed to a modified webpage that includes a specific model of a product and/or contact information custom to the particular user.

In one embodiment, the content may be modified further based on information associated with the user. For example, the user may be identified on a webpage based on an IP address of a registered endpoint device, login information, and the like. Such use of the user information is only permitted with the user consent (e.g., the user providing affirmative consent that the user's information, e.g., account information and/or past user interactions will be used to customized the content). Using the webpage example above, the modified content may include troubleshooting solutions to an endpoint device that is owned by the user.

In one embodiment, a notification may be presented to the user asking a user to confirm that they would like to receive the modified content. In other words, the user may have the option to navigate through the series of selections in the content. For example, the context may be incorrectly predicted and/or the user may be more comfortable looking for a desired outcome manually through the default series of selections. Historical data of such user feedback may be used to further improve predictions.

At step 310, the processing system presents the content that is modified to a user. In an example, the modified content may be presented visually in a graphical user interface (e.g., a webpage). In another example, the modified content may be presented audibly (e.g., a modified IVR menu). In another example, the modified content may be presented as a modified video content. The video content may be automatically edited to only include portions or scenes that the user may be looking for based on the identified context.

In one embodiment, the modified content may provide a visual representation of how the content was modified. Thus, the user may go back and provide different selections. The processing system may then automatically propagate the changes through the sequence of selections to update the context and/or the modified content.

In one embodiment, the context and the corresponding modified context may be continuously updated as the user makes additional selections. For example, the user may change selections, or may make additional selections at waypoints during interaction with the content. When selections are changed, different sequences of known user interactions may be identified. Thus, the content may be updated with custom selections associated with the different sequence of known user interactions.

In one embodiment, the user may jump to other types of content or different portions of the modified content using wormholes. This may cause the processing system to dynamically update the context and the corresponding modified content accordingly. The additional selections and changes may be used to further train the machine learning model to allow the machine learning model to more accurately predict the context based on user selections within the content. At step 312, the method 300 ends.

It should be noted that the method 300 may be expanded to include additional steps, or may be modified to replace steps with different steps, to combine steps, to omit steps, to perform steps in a different order, and so forth. In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 may comprise optional steps, or can be combined, separated, and/or performed in a different order from that described above, without departing from the example embodiments of the present disclosure. The method 300 may also be expanded to include additional steps. Thus, these and other modifications are all contemplated within the scope of the present disclosure.

FIG. 4 depicts a high-level block diagram of a computing device or processing system specifically programmed to perform the functions described herein. For example, any one or more components or devices illustrated in FIG. 1 or described in connection with the method 300 may be implemented as the system 400. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for modifying content based on user interaction sequences, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 406 may also include antenna elements, transceivers, power units, and so forth. Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300, or the entire method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one example, instructions and data for the present module or process 405 for modifying content based on user interaction sequences (e.g., a software program comprising computer-executable instructions) can be loaded into memory 404 and executed by hardware processor element 402 to implement the steps, functions, or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for modifying content based on user interaction sequences (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, a context of a user selection within a content;
identifying, by the processing system, a sequence of known user interactions with the content based on the context;
modifying, by the processing system, the content to include at least one custom selection based on the sequence of known user interactions that is identified; and
presenting, by the processing system, the content that is modified to a user.

2. The method of claim 1, further comprising:
receiving, by the processing system, a selection at a waypoint;
identifying, by the processing system, a different sequence of known user interactions based on the selection at the waypoint; and
updating, by the processing system, the at least one custom selection in the content that is modified based on the different sequence of known user interactions.

3. The method of claim 2, wherein the waypoint includes a suggestion based on the sequence of known user interactions.

4. The method of claim 1, wherein the at least one custom selection includes a wormhole to allow a user to skip to a desired portion of the content that is modified.

5. The method of claim 1, wherein the context of the user selection is identified based on an initial selection in the content.

6. The method of claim 1, wherein the context of the user selection is identified based on a plurality of responses to a plurality of testing questions presented to the user.

7. The method of claim 1, wherein the content comprises a webpage.

8. The method of claim 7, wherein the at least one custom selection comprises a custom selection that is different from default selections in the webpage.

9. The method of claim 1, wherein the content comprises a plurality of interactions with an interactive voice response system.

10. The method of claim 9, wherein the at least one custom selection comprises an action associated with a numerical key that is different than default actions associated with numerical keys of the plurality of interactions with the interactive voice response system.

11. The method of claim 1, wherein the content comprises a video.

12. The method of claim 11, wherein the at least one custom selection comprises a sequence of portions of the video that is different than a default sequence of the video.

13. The method of claim 1, wherein a graphical representation of the content that is modified is presented to the user.

14. The method of claim 13, wherein the graphical representation includes all available selections of the content and distinguishes any selection that is included in the at least one custom selection.

15. The method of claim 13, wherein the graphical representation includes one or more selections that were made by the user to identify the context of the user selection.

16. The method of claim 15, further comprising:
receiving, by the processing system, a change to one of the one or more selections that were made by the user to identify the context of the user selection;
identifying, by the processing system, an updated context based on the change;
identifying, by the processing system, a new sequence of known user interactions with the content based on the update context;
modifying, by the processing system, the content to include at least one updated custom selection based on the new sequence of known user interactions that is identified; and
presenting, by the processing system, the content that is modified with the at least one updated custom selection to the user.

17. The method of claim 1, wherein the content is continuously modified to include additional custom selections based on changes to the context and changes to the sequence of known user interactions with the content based on the changes to the context.

18. The method of claim 1, wherein the at least one custom selection is based on user account information.

19. An apparatus comprising:
a processing system including at least one processor; and
a non-transitory computer-readable medium storing instructions which, when executed by the processing system, cause the processing system to perform operations, the operations comprising:
identifying a context of a user selection within a content;
identifying a sequence of known user interactions with the content based on the context;
modifying the content to include at least one custom selection based on the sequence of known user interactions that is identified; and
presenting the content that is modified to a user.

20. A non-transitory computer-readable medium storing instructions which, when executed by a processing system including at least one processor, cause the processing system to perform operations, the operations comprising:
identifying a context of a user selection within a content;
identifying a sequence of known user interactions with the content based on the context;
modifying the content to include at least one custom selection based on the sequence of known user interactions that is identified; and
presenting the content that is modified to a user.
